(19) United States
(12) Patent Application Publication
(10) Pub. No.: US 2019/0354100 A1
(43) Pub. Date: Nov. 21, 2019

(54) BAYESIAN CONTROL METHODOLOGY FOR THE SOLUTION OF GRAPHICAL GAMES WITH INCOMPLETE INFORMATION

(71) Applicant: Board of Regents, The University of Texas System, Austin, TX (US)

(72) Inventors: Victor G. Lopez Mejia, Arlington, TX (US); Yan Wan, Plano, TX (US); Frank L. Lewis, Arlington, TX (US)

(21) Appl. No.: 16/411,938

(22) Filed: May 14, 2019

Related U.S. Application Data
(60) Provisional application No. 62/674,076, filed on May 21, 2018.

(51) Int. Cl. G05D 1/00; G06N 7/00; G06N 20/20

(52) U.S. Cl. CPC G05D 1/0088; G06N 20/20; G06N 7/00

(57) ABSTRACT

Disclosed are systems and methods relating to dynamically updating control systems according to observations of behaviors of neighboring control systems in the same environment. A control policy for an agent device is established based on an incomplete knowledge of an environment and goals. State information from neighboring agent devices can be collected. A belief in an intention of the neighboring agent device can be determined based on the state information and without knowledge of the actual intention of the neighboring agent device. The control policy can be updated based on the updated belief.

### CROSS-REFERENCE TO RELATED APPLICATION

This application claims priority to co-pending U.S. Provisional Application Ser. No. 62/674,076, filed May 21, 2018, which is hereby incorporated by reference herein in its entirety.

### STATEMENT REGARDING FEDERALLY SPONSORED RESEARCH OR DEVELOPMENT

This invention was made with government support under grant number N00014-17-1-2239 awarded by Office of Naval Research and grant numbers 1714519 and 1730675 awarded by the National Science Foundation (NSF). The Government has certain rights in the invention.

### BACKGROUND

Game theory has become one of the most useful tools in multiagent systems analysis due to their rigorous mathematical representation of optimal decision making. Differential games have been studied with increasing interest because they encompass the need of the players to consider the evolution of their payoff functions along time rather than static, immediate costs per action. The general approach to differential games is to expand the single-agent optimal control techniques to groups of agents with both common and conflicting interests.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1B illustrate diagrams of examples of a control system for controlling an agent in a multi-agent environment according to various embodiments of the present disclosure.

FIG. 2 illustrates an example of a directed graph a communication topology of a multi-agent environment according to various embodiments of the present disclosure.

FIGS. 3A and 3B illustrate examples of graphical representations of trajectories for different agents in the multi-agent environment of FIG. 2 according to various embodiments of the present disclosure.

FIG. 4 illustrates an example of a graphical representation of beliefs of the agents with a Bayesian update according to various embodiments of the present disclosure.

FIG. 5 illustrates an example of a graphical representation of beliefs of the agents with a non-Bayesian update according to various embodiments of the present disclosure.

FIG. 6 is a schematic block diagram that provides one example illustration of an agent controller system employed in the multi-agent environment according to various embodiments of the present disclosure.

### DETAILED DESCRIPTION

Disclosed herein are various embodiments related to artificial and intelligent control systems. Specifically, the present disclosure relates to a multi-level control system that optimizes control based on observations of the behavior of other control systems in an environment where the control systems have the same and/or conflicting interests. According to various embodiments of the present disclosure, a control system can update a control policy as well as a belief of each of the neighboring systems based on observations of a systems neighbors. The belief update and the control update can be combined to dynamically influence control decisions of the overall system.

The multi-level control system of the present disclosure can be implemented in different types of agents, such as, for example, unmanned aerial vehicles (UAV), unmanned ground vehicles (UGV), autonomous vehicles, electrical vehicles, industrial process control (e.g., robotic assembly lines, etc.), and/or other types of systems that may require decision making based on uncertainty in a surrounding environment. In an environment where multiple agents perform certain actions towards their own goals, each agent needs to make decisions based on their imperfect knowledge of the surrounding environment.

For example, assume an environment including a plurality of autonomous vehicles. Each vehicle may have its own set of goals (e.g., keep passengers safe, save fuel, keep traffic fluent, etc.). However, in some instances the goals of one vehicle may be in conflict with another vehicle and the goals may need to be updated over time. According to various embodiments of the present disclosure, the agents can make their decisions based on their own observations of their neighbors' behaviors. When the agents have conflicting interests, the agents are able to optimize their actions in every situation without have full knowledge of their neighbors' intentions, but rather on their belief of what the neighbors intentions are based on observations.

The goals of each agent depend on the agent's current knowledge and the knowledge of other agent's behavior. When an agent's control policy is established for the first time, the control policy is based on prior beliefs about the neighbor's behavior. However, as the system evolves over time in achieving its goals, the agent is able to collect more information about the neighbor's behaviors and can update its own actions accordingly.

According to various embodiments, each agent starts with a prior information (e.g., rules) about a Bayesian game, and must then collect the evidence that his environment provides to update their epistemic beliefs about the game. By combining the Hamilton-Jacobi-Isaacs (HJI) equations with the Bayesian algorithm to include the beliefs of the agents as a parameter, the control policies based on the solution of these equations are proven to be the best responses of the agents in a Bayesian game. Furthermore, a belief-update algorithm is presented for the agents to incorporate the new evidence that their experience throughout the game provides, improving their beliefs about the game.

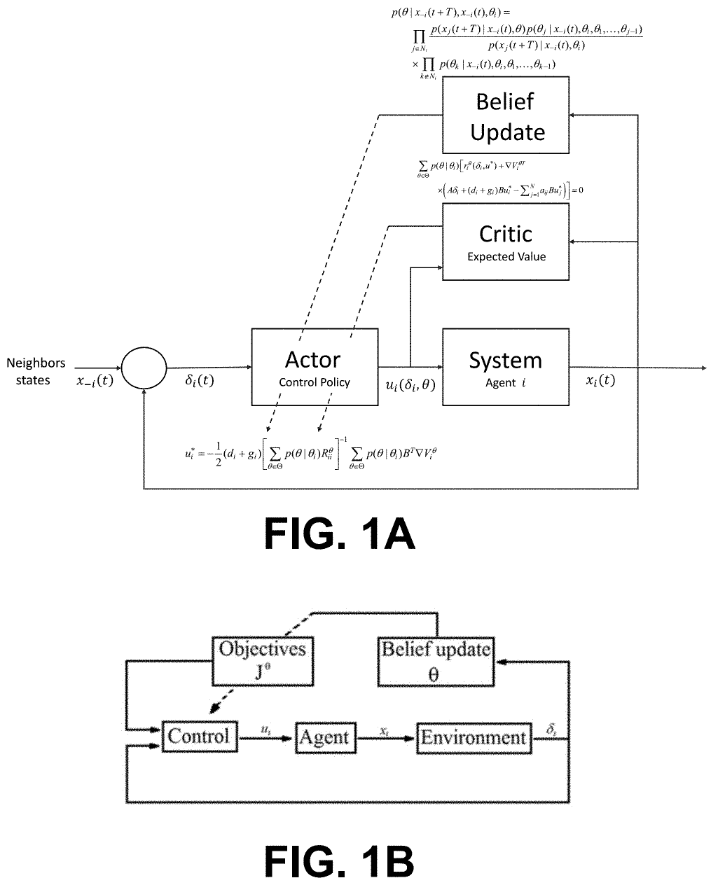

Turning now to FIGS. 1A and 1B, shown are diagrams illustrating a flow of a control system for controlling an agent in a multi-agent environment according to various embodiments of the present disclosure. As shown in FIG. 1A, the control system of an agent receives state information from one or more neighbors in a multi-agent environment. This information (e.g., neighbor's instant behaviors) can be used as a reference to update the belief update of the intentions of the neighbors by the particular agent. The control policy can then be updated in real-time without requiring the agents to assume a complete knowledge of the game and/or intentions of the other agents.

Game theory has become one of the most useful tools in multiagent systems analysis due to their rigorous mathematical representation of optimal decision making. Differential games have been studied with increasing interest because they encompass the need of the players to consider the evolution of their payoff functions along time rather than static, immediate costs per action. The general approach to differential games is to expand the single-agent optimal control techniques to groups of agents with both common and conflicting interests. Thus, the agents' optimal strategies are based on the solution of a set of coupled partial differential equations, regarded as the Hamilton-Jacobi-Isaacs (HJI) equations defined by the cost function and the dynamics of each agent. It is proven that, if the solutions of the HJI equations exist, then Nash equilibrium is achieved in the game and no agent can unilaterally change his control policy without producing a lower performance for himself.

A more general case has been described with the study of graphical games, in which the agents are taken as nodes in a communication graph with a well-defined topology, such that each agent can only measure the state of the agents connected to him through the graph links and regarded as neighbors.

A downside of these standard differential games solutions is the assumption that all agents are fully aware of all the aspects of the game being played. The agents are usually defined with the complete knowledge about themselves, their environment, and all other players in the game. In complex practical applications, the agents operate in fast-evolving and uncertain environments which provide them with incomplete information about the game. A dynamic agent facing other agents for the first time, for example, may not be certain of their real intentions or objections.

Bayesian games, or games with incomplete information, describe the situation on which the agents participate in an unspecified game. The true intentions of the other players may be unknown, and each agent must adjust his objectives accordingly. The initial information of each agent about the game, and the personal experience gained during his interaction with other agents through the network topology, form the basis for the epistemic analysis of the dynamical system. The agents must collect the evidence provided by their environments and use it to update their beliefs about the state of the game. Thus, the aim is to develop belief assurance protocols, distributed control protocols, and distributed learning mechanisms to induce optimal behaviors with respect to an expected cost function.

Bayesian games are defined for static agents and it is shown that the solution of the game consist on the selection of specific actions with a given probability. In the present disclosure, Bayesian games are defined for dynamic systems and the optimal control policies vary as the belief of the agents change. The ex post stability in Bayesian games consists of a solution that would not change if the agents were fully aware of the conditions of the game. The results of the present disclosure are shown not to be ex post stable because the agents are allowed to improve their policies as they collect new information. Different learning algorithms for static agents in Bayesian games have been studied, but not for differential graphical games per knowledge of the authors.

Potential applications for the proposed Bayesian games for dynamical systems include collision avoidance in automatic transport systems, sensible decision making against possibly hostile agents and optimal distribution of tasks in cooperative environments. As the number of autonomous agents increase in urban areas, the formulation of optimal strategies for unknown scenarios becomes a necessary development.

According to various embodiments, the present disclosure relates to a novel description of Bayesian games for continuous-time dynamical systems, which requires an adequate definition of the expected cost that is to be minimized by each agent. This leads to the definition of the Bayes-Nash equilibrium for dynamical systems, which is obtained by solving a set of HJI equations that include the epistemic beliefs of the agents as a parameter. These partial differential equations are called the Bayes-Hamilton-Jacobi-Isaacs (BHJI) equations. This disclosure reveals the tight relationship between the beliefs of an agent and his distributed best response control policy. As an alternative to Nash equilibrium, minmax strategies for Bayesian games are proposed. The beliefs of the agents are constantly updated throughout the game using the Bayesian rule to incorporate new evidence to the individual current estimates of the game. Two belief update algorithms that do not require the full knowledge of graph topology are developed. The first of these algorithms is a direct application of the Bayesian rule and the second is a modification regarded as a non-Bayesian update.

Bayesian Games

Many practical applications of game-theoretic models require considering players with incomplete knowledge about their environments. The total number of players, the set of all possible actions for each player, and the actual payoff received when a certain action is played are aspects of the games that can be unknown to the agents. The category of games that studies this scenario is regarded as Bayesian games, or games with incomplete information.

The information that is unknown by the agents in a Bayesian game can often be captured as an uncertainty about the payoff received by the agents after their actions are played. Thus, the players are presented with a set of possible games, one of which is actually being played. Being aware of their lack of knowledge, the agents must define a probability distribution over the set of all possible games they may be engaged on. These probabilities are the beliefs of an agent.

At the beginning of the game, the agents have two types of knowledge. First, a common prior is assumed to be known by all the agents, and is taken as the starting point for them to make rational inferences about the game. In repeated games, the common prior is updated individually based on the information that each agent is able to collect from his experiences. Second, the agents start with some personal information, only known by themselves, and regarded as their epistemic type. The objective of an agent during the game depends on his current type and the types of the other agents.

For each of the N agents, define the epistemic type space that represents the set of possible goals and the private information available to the agent. The epistemic type space for agent i is defined as Θᵢ{θᵢ¹, . . . , θᵢ^{M}^{ᵢ}}, where θᵢ^{k}, k=1, . . . , Mᵢ, represent the different epistemic types on which agent i can be found at the beginning of the game. When there is no risk of ambiguity, the notation representing the current type of agent i as θᵢ can be eased.

Formally, a Bayesian game for N players is defined as a tuple (N, A, Θ, P, J), where N is the set of agents in the game, A=A₁× . . . ×A_{N}, with Aᵢ the set of possible actions of agent i, Θ=Θ₁× . . . ×Θ_{N} with Θᵢ the type space of player i, P:Θ→[0,1] expresses the probability of finding every agent i in type θᵢ^{k}, k=1, . . . , Mᵢ, and the payoff function of the agents are J=(J₁, . . . , J_{N}).

Differential Graphical Games

Differential graphical games capture the dynamics of a multiagent system with limited sensing capabilities; that is, every player in the game can only interact with a subset of the other players, regarded as his neighbors. Consider a set of N agents connected by a communication graph G=(V,E). The edge weights of the graph are represented as aᵢⱼ, with aᵢⱼ>0 if (vⱼ,vᵢ)∈E and aᵢⱼ=0 otherwise. The set of neighbors of node vⱼ is Nᵢ={vⱼ:aᵢⱼ>0}. By assumption, there are no self-loops in the graph, i.e., aᵢᵢ=0 for all players i. The weighted in-degree of node i is defined as dᵢ=Σⱼ₌₁^{N}aᵢⱼ.

A canonical leader-follower synchronization game can be considered. In particular, each node of the graph Gr represents a player of the game, consisting on a dynamical system with linear dynamics as

\dot{x}ᵢ=Axᵢ=Buᵢ, i=1, . . . ,N (1)
where xᵢ(t)∈ [symbol] ⁿ is the vector of state variables, and uᵢ∈ [symbol] ^{m} is the control input vector of agent i. Consider an extra node, regarded as the leader or target node, with state dynamics

\dot{x}₀=Ax₀. (2)

The leader is connected to the other nodes by means of the pinning gains gᵢ≥0. The disclosed methods relate to the behavior of the agents with the general objective of achieving synchronization with the leader node x₀.

Each agent is assumed to observe the full state vector of his neighbors in the graph. The local synchronization error for agent i is defined as

$${δ}_{i} = {\sum }_{j = 1}^{N} {a}_{ij} ( {x}_{i} - {x}_{j} ) + {g}_{i} ( {x}_{i} - {x}_{0} ) . \qquad ( 3 )$$

and the local error dynamics are

$$\begin{matrix}{\dot{δ}}_{i} = {\sum }_{j = 1}^{N} {a}_{ij} ( {\dot{x}}_{i} - {\dot{x}}_{j} ) + {g}_{i} ( {\dot{x}}_{i} - {\dot{x}}_{0} ) \\ = A {δ}_{i} + ( {d}_{i} + {g}_{i} ) {Bu}_{i} - {\sum }_{j = 1}^{N} {a}_{ij} {Bu}_{j} .\end{matrix} \qquad ( 4 )$$

where the dynamics in Equations (1)-(2) have been incorporated.

Each agent i expresses his objective in the game by defining a performance index as

Jᵢ(δᵢ,δ₋ᵢ,uᵢ,u₋ᵢ)=∫₀^{∞}rᵢ(δᵢ,δ₋ᵢ,uᵢ,u₋ᵢ)dt, (5)
where rᵢ(δᵢ,δ₋ᵢ,uᵢ,u₋ᵢ) is selected as a positive definite scalar function of the variables expected to be minimized by agent i, with δ₋ᵢ and u₋ᵢ the local errors and control inputs of the neighbors of agent i, respectively. For synchronization games, rᵢ can be selected as

$${r}_{i} ( {δ}_{i} , {δ}_{- i} , {u}_{i} , {u}_{- i} ) = {\sum }_{j = 0}^{N} {a}_{ij} ( {\overline{δ}}_{ij}^{T} {Q}_{ij} {\overline{δ}}_{ij} + {u}_{i}^{T} {R}_{ii} {u}_{i} + {u}_{j}^{T} {R}_{ij} {u}_{j} ) , \qquad ( 6 )$$

where Qᵢⱼ=Qᵢⱼ^{T}≥0, Rᵢᵢ=Rᵢᵢ^{T}>0, aᵢ₀=gᵢ, δ̅ᵢ₀=[δᵢ^{T} 0^{T}]^{T}, δ̅ᵢⱼ=[δᵢ^{T} δⱼ^{T}]^{T}, for j≠0, and u₀=0. It is also presented in a simplified form,

$${r}_{i} ( {δ}_{i} , {u}_{i} , {u}_{- i} ) = {δ}_{i}^{T} {Q}_{i} {δ}_{i} + {u}_{i}^{T} {R}_{ii} {u}_{i} + {\sum }_{j = 1}^{N} {a}_{ij} {u}_{j}^{T} {R}_{ij} {u}_{j} , \qquad ( 7 )$$

which is widely employed in the differential graphical games literature.

The dependence of Jᵢ on δ₋ᵢ and u₋ᵢ does not imply that the optimal control policy, uᵢ*, requires these variables to be computed by agent i. The definition of Jᵢ, therefore, yields a valid distributed control policy as solution of the game.

The best response of agent i for fixed neighbor policies u₋ᵢ is defined as the control policy uᵢ* such that the inequality Jᵢ(uᵢ*,u₋ᵢ)≤Jᵢ(uᵢ,u₋ᵢ) holds for all policies uᵢ. Nash equilibrium is achieved if every agent plays his best response with respect to all his neighbors, that is,

Jᵢ(δ,uᵢ*,u₋ᵢ*)≤Jᵢ(δ,uᵢ,u₋ᵢ*) (8)
for all agents i=1, . . . , N.

From the performance indices (5) it is possible to define the set of coupled partial differential equations

rᵢ(δ,uᵢ*,u₋ᵢ*)+\dot{V}ᵢ(δ)=0, (1)
regarded as the Hamilton-Jacobi-Isaacs (HJI) equations, and where Vᵢ(δ) is the value function of agent i. The following assumption provides a condition to obtain distributed control policies for the agents. Assumption 1. Let the solutions of the HJI equations (9) be distributed, in the sense that they contain only local information, i.e., Vᵢ(δ)=Vᵢ(δᵢ).

It is proven that, if Assumption 1 holds, the best response of agent i with cost function defined by Equations (5) and (7) is given by

uᵢ*=−½(dᵢ+gᵢ)Rᵢᵢ⁻¹B^{T}∇Vᵢ(δᵢ), (10)
where the functions Vᵢ(δᵢ) solve the HJI Equations,

$${r}_{i} ( δ , {u}_{i} , {u}_{- i} ) + ∇ {V}_{i}^{T} ( A {δ}_{i} + ( {d}_{i} + {g}_{i} ) {Bu}_{i}^{*} - {\sum }_{j = 1}^{N} {a}_{ij} {Bu}_{j}^{*} ) = 0. \qquad ( 11 )$$

Bayesian Graphical Games for Dynamic Systems

The following discusses the new Bayesian graphical games for dynamical systems, combining both concepts explained above. The main results on the formulation of Bayesian games for multiagent dynamical systems connected by a communication graph and the analysis of the conditions to achieve Bayes-Nash equilibrium in the game are presented below.

Formulation

Consider a system of N agents with linear dynamics of Equation (1) distributed on a communication graph G and with leader state dynamics of Equation (2). The local synchronization errors are defined as in Equations (3) and (4).

The desired objectives of an agent can vary depending on his current type and those of his neighbors. This condition can be expressed by defining the performance index of agent i as

Jᵢ^{θ}(δᵢ,uᵢ,u₋ᵢ)=∫₀^{∞}rᵢ^{θ}(δᵢ,uᵢ,u₋ᵢ)dt, (12)
where θ refers to the set of current types of all the agents in the game, θ=θ₁× . . . ×θ_{N}, and each function rᵢ^{θ} is defined for that particular combination of types. With this information, a new category of game concept is defined as follows.

### Definition 1

A Bayesian graphical game for dynamical systems is defined as a tuple (N, X, U, Θ, P, J) where N is the set of agents in the game, X=X₁× . . . ×X_{N} is a set of states with X, the set of reachable states of agent i, U=U₁× . . . ×U_{N}, with Uᵢ the set of admissible controllers for agent i, and Θ=Θ₁× . . . ×Θ_{N} with Θᵢ the type space of player i. The common prior over types P:Θ→[0,1] describes the probability of finding every agent i in type θᵢ^{k}∈Θᵢ, k=1, . . . , M, at the beginning of the game. The performance indices J=(J₁, . . . , J_{N}), with Jᵢ:X×U×Θ→□ are the costs of every agent for the use of a given control policy in a state value and a particular combination of types.

Define the set Δᵢ=X₁ⁱ× . . . ×X_{N}ⁱ, where Xⱼⁱ is the set of possible states of the jth neighbor of agent i; that is, Δᵢ represents the set of states that agent i can observe from the graph topology.

It is assumed that the sets N, X, U, P, and J are of common prior for all the agents before the game starts. However, the set of states Δᵢ and the actual type θᵢ are known only by agent i. The objective of every agent in the game is now to use their (limited) knowledge about δᵢ and θ to determine the control policies uᵢ*(δᵢ,θ), such that every agent expects to minimize the cost he pays during the game according to the cost functions of Equation (12).

To fulfill this objective, a different cost index formulation is required to allow the agents to determine their optimal policies according to their current beliefs about the global type θ. This requirement is addressed by defining the expected cost of agent i.

Expected Cost

In the Bayesian games' literature, three different concepts of expected cost are usually defined, namely the ex post, the ex interim, and the ex ante expected costs, that differ in the information available for their computation.

The ex post expected cost of agent i considers the actual types of all agents of the game. For a given Bayesian game (N, X, U, Θ, P, J), where the agents play with policies uᵢ and the global type is θ, the ex post expected utility is defined as

EJᵢ(δᵢ,uᵢ,u₋ᵢ,θ)=Jᵢ^{θ}(δᵢ,uᵢ,u₋ᵢ) (13)

The ex interim expected cost of agent i is computed when i knows its own type, but the types of all other agents are unknown. Note that this case applies if the agents calculate their expected costs once the game has started. Given a Bayesian game (N, X, U, Θ, P, J), where the agents play with policies u, and the type of agent i is θᵢ, the ex interim expected cost is

$${EJ}_{i} ( {δ}_{i} , {u}_{i} , {u}_{- i} , {θ}_{i} ) = {\sum }_{θ ∈ Θ} p ( θ \vert {δ}_{i} , {θ}_{i} ) {J}_{i}^{θ} ( {δ}_{i} , {u}_{i} , {u}_{- i} ) , \qquad ( 14 )$$

where p(θ|δᵢ,θᵢ) is the probability of having global type θ, given the information that agent i has type θᵢ, and the summation index θ∈Θ indicates that all possible combination of types in the game must be considered.

The ex ante expected cost can be defined for the case when agent i is ignorant of the type of every agent, including itself. This can be seen as the expected cost that is computed before the game starts, such that the agents do not know their own types. For a given Bayesian game (N, X, U, Θ, P, J) and given the control policies u, for all the agents, the ex ante expected cost for agent i is defined as

$${EJ}_{i} ( {δ}_{i} , {u}_{i} , {u}_{- i} ) = {\sum }_{θ ∈ Θ} p ( θ \vert {δ}_{i} ) {J}_{i}^{θ} ( {δ}_{i} , {u}_{i} , {u}_{- i} ) . \qquad ( 15 )$$

According to various embodiments, ex interim expected cost is used as the objective for minimization of every agent, such that they can compute it during the game.

Best Response Policy and Bayes-Nash Equilibrium

In the following, the optimal control policy uᵢ* for every agent is obtained, and conditions for Bayes-Nash equilibrium are provided.

Using Definition 2, the best response of an agent in a Bayesian game for given fixed neighbor strategies u₋ᵢ is defined as the control policy that makes the agent pay the minimum expected cost. Formally, agent i's best response to control policies u₋ᵢ are given by

$${u}_{i}^{*} = {arg min}_{{u}_{i}} {EJ}_{i} ( {δ}_{i} , {u}_{i} , {u}_{- i} , θ ) \qquad ( 16 )$$

Now, it is said that a Bayes-Nash equilibrium is reached in the game if each agent plays a best response to the strategies of the other players during a Bayesian game. The Bayes-Nash equilibrium is the most important solution concept in Bayesian graphical games for dynamical systems. Definition 2 formalizes this idea.

### Definition 2

A Bayes-Nash equilibrium is a set of control policies u=₁× . . . ×U_{N} that satisfies uᵢ=uᵢ*, as in Equation (16), for all agents i, such that

EJᵢ(δᵢ,uᵢ*,u₋ᵢ*)≤EJᵢ(δᵢ,uᵢ,u₋ᵢ*) (17)
for any control policy uᵢ.

Following an analogous procedure to single-agent optimal control, define the value function of agent i, given the types of all agents θ, as

Vᵢ^{θ}(δᵢ,uᵢ,u₋ᵢ)=∫ᵢ^{∞}rᵢ^{θ}(δᵢ,uᵢ,u₋ᵢ)dτ, (18)
with rᵢ^{θ} as defined in Equation (12). The expected value function for a control policy uᵢ is defined as

$${EV}_{i} ( {δ}_{i} , {u}_{i} , {u}_{- i} , θ ) = {\sum }_{θ ∈ Θ} p ( θ \vert {δ}_{i} , {θ}_{i} ) {V}_{i}^{θ} ( {δ}_{i} , {u}_{i} , {u}_{- i} ) , \qquad ( 19 )$$

where agent i knows his own epistemic type.

Function (19) can be used to define the expected Hamiltonian of agent i as

$${EH}_{i} ( {δ}_{i} , u , θ ) = {\sum }_{θ ∈ Θ} p ( θ \vert {δ}_{i} , {θ}_{i} ) \times [ {r}_{i}^{θ} ( {δ}_{i} , u ) + ∇ {V}_{i}^{θ T} ( A {δ}_{i} + ( {d}_{i} + {g}_{i} ) {Bu}_{i} - {\sum }_{j = 1}^{N} {a}_{ij} {Bu}_{j} ) ] . \qquad ( 20 )$$

The expected Hamiltonian (20) is now employed to determine the best response control policy of agent i by computing its derivative with respect to u, and equating it to zero. This procedure yields the optimal policy

$${u}_{i}^{*} = - \frac{1}{2} {( {d}_{i} + {g}_{i} ) [ {\sum }_{θ ∈ Θ} p ( θ \vert {θ}_{i} ) {R}_{ii}^{θ} ]}^{- 1} {\sum }_{θ ∈ Θ} p ( θ \vert {θ}_{i} ) {B}^{T} ∇ {V}_{i}^{θ} \qquad ( 21 )$$

As in the deterministic multiplayer nonzero-sum games, the functions Vᵢ^{θ}(δᵢ) are the solutions of a set of coupled partial differential equations. For the setting of Bayesian games, the novel concept of the Bayes-Hamilton-Jacobi-Isaacs (BHJI) equations is introduced, given by

$${\sum }_{θ ∈ Θ} p ( θ \vert {θ}_{i} ) [ {r}_{i}^{θ} ( {δ}_{i} , {u}^{*} ) + ∇ {V}_{i}^{θ T} \times ( A {δ}_{i} + ( {d}_{i} + {g}_{i} ) {Bu}_{i}^{*} - {\sum }_{j = 1}^{N} {a}_{ij} {Bu}_{j}^{*} ) ] = 0 \qquad ( 22 )$$

Remark 1.

The optimal control policy defined by Equation (21) establishes for the first time, the relation between belief and distributed control in multi-agent systems with unawareness. Each agent should compute his best response by observing only his immediate neighbors. This is distributed computation with bounded rationality imposed by the communication network.

Remark 2.

Notice that the probability terms in Equation (21) have the properties 0≤p(θ|δᵢ,θᵢ)≤1 and Σ_{θ∈Θ}p(θ|θᵢ)=1. Therefore, Equation (20) is a convex combination of the Hamiltonian functions defined for each performance index defined by Equation (12) for agent i, and Equation (21) is the solution of a multiobjective optimization problem using the weighted sum method.

Remark 3.

The solution obtained by means of the minimization of the expected cost does not represent an increase in complexity when compared to the optimization of a single performance index. Only the number of sets of coupled HJI equations increases according to the total number of combination of types of the agents.

Remark 4.

If there is a time t_{f} at which agent i is convinced of the global type θ with probability 1, then the problem is reduced to a single objective optimization problem and the solution is given by the deterministic control policy

uᵢ*=½(Rᵢᵢ^{θ})⁻¹B^{T}∇Vᵢ^{θ}(δᵢ).

In the particular case when the value function associated with each Jᵢ^{θ} has the quadratic form

Vᵢ^{θ}=δᵢ^{T}Pᵢ^{θ}δᵢ, (23)

the optimal policy defined by Equation (21) can be written in terms of the states of agent i and his neighbors as

$${u}_{i}^{*} = - {( {d}_{i} + {g}_{i} ) [ {\sum }_{θ ∈ Θ} p ( θ \vert {θ}_{i} ) {R}_{ii}^{θ} ]}^{- 1} {\sum }_{θ ∈ Θ} p ( θ \vert {θ}_{i} ) {B}^{T} {P}_{i}^{θ} {δ}_{i} . \qquad ( 24 )$$

The next technical lemma shows that the Hamiltonian function for general policies uᵢ, u₋ᵢ can be expressed as a quadratic form of the optimal policies uᵢ* and u₋ᵢ* defined in Equation (21).

Lemma 1.

Given the expected Hamiltonian function defined by Equation (20) for agent i and the optimal control policy defined by Equation (21), then

$${EH}_{i} ( {δ}_{i} , {u}_{i} , {u}_{- i} ) = {EH}_{i} ( {δ}_{i} , {u}_{i}^{*} , {u}_{- i} ) + {\sum }_{θ ∈ Θ} p ( θ \vert {θ}_{i} ) {( {u}_{i} - {u}_{i}^{*} )}^{T} {R}_{ii}^{θ} ( {u}_{i} - {u}_{i}^{*} ) . \qquad ( 25 )$$

Proof.

The proof is similar to the proof of Lemma 10.1-1 in F. L. Lewis, D. Vrabie and V. L. Syrmos, Optimal Control, 2nd ed. New Jersey: John Wiley & Sons, inc., 2012, performed by completing the squares in Equation (20) to obtain

$${EH}_{i} ( {δ}_{i} , u , θ ) = {\sum }_{θ ∈ Θ} p ( θ \vert {θ}_{i} ) \times [ {δ}_{i}^{T} {Q}_{i}^{θ} {δ}_{i} + {u}_{i}^{T} {R}_{ii}^{θ} {u}_{i} + {\sum }_{j = 1}^{N} {a}_{ij} {u}_{j}^{T} {R}_{ij}^{θ} {u}_{j} + {u}_{i}^{* T} {R}_{ii}^{θ} {u}_{i}^{*} - {u}_{i}^{* T} {R}_{ii}^{θ} {u}_{i}^{*} + ( {d}_{i} + {g}_{i} ) ∇ {V}_{i}^{θ T} {Bu}_{i}^{*} - ( {d}_{i} + {g}_{i} ) ∇ {V}_{i}^{θ T} {Bu}_{i}^{*} + ∇ {V}_{i}^{θ T} ( A {δ}_{i} + ( {d}_{i} + {g}_{i} ) {Bu}_{i} - {\sum }_{j = 1}^{N} {a}_{ij} {Bu}_{j} ) ]$$

and conducting algebraic operations to obtain Equation (25).

The following theorem extends the concept of Bayes-Nash equilibrium to differential Bayesian games and shows that this Bayes-Nash equilibrium is achieved by means of the control policies defined by Equation (21). The proof is performed using the quadratic cost functions as in Equation (7), but it can easily be extended to other functions as shown in Equation (6).

Theorem 1.

Bayes-Nash Equilibrium. Consider a multiagent system on a communication graph, with agents' dynamics (1) and target node dynamics (2). Let Vᵢ^{θ}*(δᵢ), i=1, . . . , N, be the solutions of the BHJI equations (22). Define the control policy uᵢ* as in Equation (21). Then, control inputs uᵢ* make the dynamics defined in Equation (4) asymptotically stable for all agents. Moreover, all agents are in Bayes-Nash equilibrium as defined in Definition 2, and the corresponding expected costs of the game are

EJᵢ*=Vᵢ^{θ}*(δᵢ(0)).

Proof.

(Stability) Take the expected value function of Equation (19) as a Lyapunov function candidate. Its derivative is given by

$$E {\dot{V}}_{i} = {\sum }_{θ ∈ Θ} p ( θ \vert {θ}_{i} ) {\dot{V}}_{i}^{θ} = {\sum }_{θ ∈ Θ} p ( θ \vert {θ}_{i} ) ∇ {V}_{i}^{θ T} {\dot{δ}}_{i} .$$

The BHJI Equation (22) is a differential version of the value functions of Equation (19) using the optimal control policies of Equation (21). As Vᵢ^{θ} satisfies Equation (22), then

$$E {\dot{V}}_{i} = - {\sum }_{θ ∈ Θ} p ( θ \vert {θ}_{i} ) ( {δ}_{i}^{T} {Q}_{i}^{θ} {δ}_{i} + {u}_{i}^{T} {R}_{ii}^{θ} {u}_{i} + {\sum }_{j = 1}^{N} {a}_{ij} {u}_{j}^{T} {R}_{ij}^{θ} {u}_{j} ) < 0$$

and the dynamics of Equation (4) are asymptotically stable.

(Bayes-Nash equilibrium) Note that Vᵢ^{θ}(δᵢ(∞))=Vᵢ^{θ}(0)=0 because of the asymptotic stability of the system. Now, the expected cost of the game for agent i is expressed as

$${EJ}_{i} = {\sum }_{θ ∈ Θ}^{ } p ( θ \vert {θ}_{i} ) {\int }_{0}^{∞} ( {δ}_{i}^{T} {Q}_{i}^{θ} {δ}_{i} + {u}_{i}^{T} {R}_{ii}^{θ} {u}_{i} + {\sum }_{j = 1}^{N} {a}_{ij} {u}_{j}^{T} {R}_{ij}^{θ} {u}_{j} ) dt + {\sum }_{θ ∈ Θ}^{ } p ( θ \vert {θ}_{i} ) {\int }_{0}^{∞} {\dot{V}}_{i}^{θ} dt + {\sum }_{θ ∈ Θ}^{ } p ( θ \vert {θ}_{i} ) {V}_{i}^{θ} ( {δ}_{i} ( 0 ) ) = {\int }_{0}^{∞} {EH}_{i} ( {δ}_{i} , {u}_{i} , {u}_{- i} ) dt + {\sum }_{θ ∈ Θ}^{ } p ( θ \vert {θ}_{i} ) {V}_{i}^{θ} ( {δ}_{i} ( 0 ) ) .$$

By Lemma 1, this expression becomes

$${EJ}_{i} = {\sum }_{θ ∈ Θ}^{ } p ( θ \vert {θ}_{i} ) {V}_{i}^{θ} ( {δ}_{i} ( 0 ) ) + {\int }_{0}^{∞} {EH}_{i} ( {δ}_{i} , {u}_{i}^{*} , {u}_{- i} ) dt + {\sum }_{θ ∈ Θ}^{ } p ( θ \vert {θ}_{i} ) {\int }_{0}^{∞} {( {u}_{i} - {u}_{i}^{*} )}^{T} {R}_{ii} ( {u}_{i} - {u}_{i}^{*} ) dt$$

for all uᵢ and u₋ᵢ. Assume all the neighbors of agent i are using their best response strategies u₋ᵢ*. Then, as the BHJI equations (22) holds,

$${EJ}_{i} = {\sum }_{θ ∈ Θ}^{ } p ( θ \vert {θ}_{i} ) [ {\int }_{0}^{∞} {( {u}_{i} - {u}_{i}^{*} )}^{T} {R}_{ii} ( {u}_{i} - {u}_{i}^{*} ) dt + {V}_{i}^{θ} ( {δ}_{i} ( 0 ) ) ]$$

It can be concluded that u, minimizes the expected cost of agent i and the value of the game is EVᵢ^{θ}(δᵢ(0)).

It is of interest to determine the influence of the graph topology in the stability of the synchronization errors given by the control policies in Equation (24). A few additional definitions are required for this analysis. Define the pinning matrix of graph Gr as G=diag{gᵢ} and the Laplacian matrix as L=D−A, where A=[αᵢⱼ]∈ [symbol] ^{N} is the graph's connectivity matrix and D=diag{dᵢ}∈ [symbol] ^{N} is the in-degree matrix. Define also matrix K=diag{Kᵢ}∈ [symbol] ^{N}^{ₙ} with Kᵢ=(dᵢ+gᵢ)Rᵢ⁻¹B^{T}Pᵢ.

Theorem 2 relates the stability properties of the game with the communication graph topology Gr.

Theorem 2.

Let the conditions of Theorem 1 hold. Then, the eigenvalues of matrix [(I⊗A)−((L+G)⊗B))K]∈ [symbol] ^{n(N+M)} have all negative real parts, i.e.,

Re{λₖ((I⊗A)−((L+G)⊗B)K)}<0, (2)

for k=1, . . . , nN, where I∈ [symbol] ⁿ is the identity matrix and ⊗ stands for the Kronecker product.

Proof.

Define the vectors δ=[δ₁^{T}, . . . , δ_{N}^{T}]^{T} and u=[u₁^{T}, . . . , u_{N}^{T}]^{T}. Using the local error dynamics in Equation (4), the following can be derived:

\dot{δ}=(I⊗A)δ+((L+G)⊗B)u, (3)

Control policies of Equation (24) can be expressed as uᵢ=−Kₚᵢδᵢ, with Kᵢ=(dᵢ+gᵢ)Rᵢ⁻¹B^{T}Pᵢ. Now we can write

u=−Kδ. (4)

Substitution of Equation (28) in Equation (27) yields the global closed-loop dynamics

\dot{δ}=[(I⊗A)−((L+G)⊗B)K]δ (5)

Theorem 1 shows that if matrices P, satisfy Equation (22) then the control policies of Equation (24) make the gents achieve synchronization with the leader node. This implies that the system of Equation (29) is stable, and the condition of Equation (26) holds.

Minmax Strategies

A downside of the Nash equilibrium solution for differential graphical games is presented by the solutions of the HJI Equations (22). In the general case, there may not always exist a set of functions Vᵢ^{θ}(δᵢ) that solve the BHJI equations to provide distributed control policies as in Equation (24). This is an expected result due to the limited knowledge of the agents connected in the communication graph. If agent i does not know the state information of his neighbors, then he cannot determine their best response in the game and prepare his strategy accordingly.

Despite this inconvenience, agent i can be expected to determine a best policy for the information he has available from his neighbors. In this subsection, each agent prepares himself for the worst-case scenario in the behavior of his neighbors. The resulting solution concept is regarded as a minmax strategy and, as it is shown below, the corresponding HJI equations are generally solvable for linear systems and the resulting control policies are distributed. The following definition states the concept of minmax strategy.

### Definition 3. Minmax Strategies

In a Bayesian game, the minmax strategy of agent i is given by

$${u}_{i}^{*} = arg {min}_{{u}_{i}} {max}_{{u}_{- i}} {EJ}_{i} ( {δ}_{i} , {u}_{i} , {u}_{- i} , θ ) . \qquad ( 6 )$$

To determine the minmax strategy for agent i, the performance index of Equation (12) can be redefined and formulate a zero-sum game between agent i and his neighbors. Thus, define the performance index

$${J}_{i}^{θ} = {\int }_{0}^{∞} [ {δ}_{i}^{T} {Q}_{i}^{θ} {δ}_{i} + ( {d}_{i} + {g}_{i} ) {u}_{i}^{T} {R}_{i}^{θ} {u}_{i} - {\sum }_{j = 1}^{N} {a}_{ij} {u}_{j}^{T} {R}_{j} {u}_{j} ] dt \qquad ( 7 )$$

The solution of this zero-sum game for agent i that minimizes the expected cost of Equation (14) can be shown to be determined by

$${u}_{i}^{*} = - {[ {\sum }_{θ ∈ Θ}^{ } p ( θ \vert {θ}_{i} ) {R}_{ii}^{θ} ]}^{- 1} {\sum }_{θ ∈ Θ}^{ } p ( θ \vert {θ}_{i} ) {B}^{T} {P}_{i}^{θ} {δ}_{i} \qquad ( 8 )$$

where the matrices Pᵢ^{θ} are the solutions of the BHJI equation

It is observed that these policies are always distributed, in contrast to the policies for the Nash solution given by Equation (21).

Theorem 3. Minmax Strategies for Bayesian Games.

Let the agents with dynamics of Equation (1) and a leader with dynamics of Equation (2) use the control policies of Equation (32). Moreover, assume that the value functions have quadratic form as in Equation (23), and let matrices Pᵢ^{θ} be the solutions of Equation (33). Then, all agents follow their minmax strategy Equation (30).

Proof.

The expected Hamiltonian associated with the performance indices of Equation (31) is

$${EH}_{i} = {\sum }_{θ ∈ Θ}^{ } p ( θ \vert {θ}_{i} ) [ {δ}_{i}^{T} {Q}_{i}^{θ} {δ}_{i} + ( {d}_{i} + {g}_{i} ) {u}_{i}^{T} {R}_{i}^{θ} {u}_{i} - {\sum }_{j = 1}^{N} {a}_{ij} {u}_{j}^{T} {R}_{j}^{θ} {u}_{j} + 2 {δ}_{i}^{T} {P}_{i}^{θ} ( A {δ}_{i} + ( {d}_{i} + {g}_{i} ) {Bu}_{i} - {\sum }_{j = 1}^{N} {a}_{ij} {Bu}_{j} ) ]$$

From this equation, the optimal control policy for agent i is Equation (32) and the optimal policy for i's neighbor, agent j, is uⱼ*=−[Σ_{θ∈Θ}p(θ|θᵢ)Rⱼ^{θ}]⁻¹Σ_{θ∈Θ}p(θ|θᵢ)B^{T}Pᵢ^{θ}δᵢ. Notice that this is not the true control policy of agent j.

Substituting these control policies in EHᵢ and equating to zero, the BHJI Equation (33) is obtained. Following a similar procedure as in the proof of Theorem 1, and considering the performance indices of Equation (31), the squares are completed and express the expected cost of agent i as

$${EJ}_{i} = {\int }_{0}^{∞} [ {δ}_{i}^{T} {Q}_{i}^{θ} {δ}_{i} + {u}_{i}^{T} {R}_{i}^{θ} {u}_{i} - {\overline{u}}_{- i}^{T} {R}_{j}^{θ} {\overline{u}}_{- i} ] dt + {V}_{i}^{θ} ( {δ}_{i} ( 0 ) ) + {\int }_{0}^{∞} ∇ {V}_{i}^{θ T} ( A {δ}_{i} + ( {d}_{i} + {g}_{i} ) {Bu}_{i} - ( {d}_{i} + {g}_{i} ) {\sum }_{j = 1}^{N} {a}_{ij} {Bu}_{j} ) dt = {\int }_{0}^{∞} [ {( {u}_{i} - {u}_{i}^{*} )}^{T} {R}_{i}^{θ} ( {u}_{i} - {u}_{i}^{*} ) - {\sum }_{j = 1}^{N} {{a}_{ij} ( {u}_{j} - {u}_{j}^{*} )}^{T} {R}_{j}^{θ} ( {u}_{j} - {u}_{j}^{*} ) ] dt + {V}_{i}^{θ} ( {δ}_{i} ( 0 ) )$$

Here, the fact that Vᵢ^{θ} solves the BHJI equations as explained in the proof of Theorem 1. Equation (32) with Pᵢ^{θ} as in Equation (33) is the minmax strategy of agent i.

Remark 5.

The intuition behind the minmax strategies is that an agent prepares his best response assuming that his neighbors will attempt to maximize his performance index. As this is usually not the strategy followed by such neighbors during the game, every agent can expect to achieve a better payoff than his minmax value.

Remark 6.

The BHJI equations (33) can be expressed as

Q̅ᵢ+P̅ᵢA+A^{T}P̅ᵢ−P̅ᵢBR̅⁻¹B^{T}P̅ᵢ=0 (9)
where Q̅ᵢ=Σ_{θ∈Θ}p(θ)Qᵢ^{θ} Q̅ᵢ=Σ_{θ∈Θ}p(θ)Qᵢ^{θ}, P̅ᵢ=Σ_{θ∈Θ}p(θ)Pᵢ^{θ} and

$${\overline{R}}^{- 1} = {( {d}_{i} + {g}_{i} ) [ {\sum }_{θ ∈ Θ}^{ } p ( θ ) {R}_{i}^{θ} ]}^{- 1} - {\sum }_{j}^{ } {{a}_{ij} [ {\sum }_{θ ∈ Θ}^{ } p ( θ ) {R}_{j}^{θ} ]}^{- 1} .$$

Now, if R̅⁻¹>0, then this expression is analogous to the algebraic Riccati equation (ARE) that provides the solution of the single-agent LQR problem. Similarly to the single-agent case, Equation (34) is known to have a unique solution P̅ᵢ if (A,\sqrt{Q̅ᵢ}) is observable, (A,B) is stabilizable, and R̅⁻¹>0. As we are able to find a solution P̅ᵢ, the assumption that the value functions have quadratic form holds true.

The probabilities p(θ|θᵢ) in the control policies of Equation (21) have an initial value given by the common prior of the agents, expressed by P in Definition 1. However, as the system dynamics of Equations (1)-(2) evolve through time, all agents are able to collect new evidence that can be used to update their estimates of the probabilities of the types θ. This belief update scheme is discussed next.

Bayesian Belief Updates

According to various embodiments of the present disclosure, the belief update of the agents is performed. In some embodiments, the use of the Bayesian rule can be used to compute a new estimate given the evidence provided by the states of the neighbors. In other embodiments, a non-Bayesian approach can be used to perform the belief updates.

Epistemic Type Estimation

Let every agent in the game to revise his beliefs every T units of time. Then, using his knowledge about his type θᵢ, the previous states of his neighbors xᵢ(t), and the current state of the neighbors x₋ᵢ(t+T), agent i can perform his belief update at time t+T using the Bayesian rule as

$$p ( θ \vert {x}_{- i} ( t + T ) , {x}_{- i} ( t ) , {θ}_{i} ) = \frac{p ( {x}_{- i} ( t + T ) \vert {x}_{- i} ( t ) , θ ) p ( θ \vert {x}_{- i} ( t ) , {θ}_{i} )}{p ( {x}_{- i} ( t + T ) \vert {x}_{- i} ( t ) , {θ}_{i} )} \qquad ( 35 )$$

where p(θ|x₋ᵢ(t+T),x₋ᵢ(t),θᵢ) is agent i's belief at time t+T about the types θ, p(θ|x₋ᵢ(t),θᵢ) is agent i's beliefs at time t about θ, p(x₋ᵢ(t+T)|x₋ᵢ(t),θ) is the likelihood of the neighbors reaching the states x₋ᵢ(t+T) T time units after being in states x₋ᵢ(t) given that the global type is θ, and p(x₋ᵢ(t+T)|x₋ᵢ(t),θᵢ) is the overall probability of the neighbors reaching x₋ᵢ(t+T) from x₋ᵢ(t) regardless of every other agent's types.

Remark 7.

Although the agents know only the state of their neighbors, they need to estimate the type of all agents in the game, for this combination of types determines the objectives of the game being played.

Remark 8.

The Bayesian games have been defined using the probabilities p(θ|θᵢ). The fact that agent i uses the behavior of his neighbors can be evidence of the global type θ by expressing the probabilities p(θ|x₋ᵢ(t),θᵢ).

It is of interest to find an expression for the belief update of Equation (35) that explicitly displays distributed update terms for the neighbors and non-neighbors of agent i. In the following, such expressions are obtained for the three terms p(θ|x₋ᵢ(t),θᵢ), p(x₋ᵢ(t+T)|x₋ᵢ(t),θᵢ) and p(x₋ᵢ(t+T)|x₋ᵢ(t),θᵢ).

The likelihood function p(x₋ᵢ(t+T)|x₋ᵢ(t),θᵢ) in the Bayesian belief update rule of Equation (35) can be expressed in terms of the individual positions of each neighbor of agent i as the joint probability

p(x₋ᵢ(t+T)|x₋ᵢ(t),θ)=p(x₁ⁱ(t+T), . . . ,x_{N}_{ᵢ}ⁱ(t+T)|x₋ᵢ(t),θ), (36)

where xⱼⁱ(t) is the state of the jth neighbor of i. Notice that xᵢ(t+T) is dependent of xᵢ(t) and of x₋ᵢ(t) by means of the control input uᵢ, for all agents i. However, the current state value of agent i, xᵢ(t+T) is independent of the current state value of his neighbors x₋ᵢ(t+T) for there has been no time for the values x₋ᵢ(t+T) to affect the policy uᵢ. Independence of the state variables at time t+T allows computing the joint probability of Equation (36) as the product of factors

$$p ( {x}_{- i} ( t + T ) \vert {x}_{- i} ( t ) , θ ) = {\prod }_{j ∈ {N}_{i}}^{ } p ( {x}_{j} ( t + T ) \vert {x}_{- i} ( t ) , θ ) . \qquad ( 37 )$$

Using the same procedure, the denominator of Equation (35), p(x₋ᵢ(t+T)|x₋ᵢ(t),θᵢ), can be expressed as the product

$$p ( {x}_{- i} ( t + T ) \vert {x}_{- i} ( t ) , {θ}_{i} ) = {\prod }_{j ∈ {N}_{i}}^{ } p ( {x}_{j} ( t + T ) \vert {x}_{- i} ( t ) , {θ}_{i} ) . \qquad ( 38 )$$

Notice that the value of p(xⱼ(t+T)|x₋ᵢ(t),θᵢ) can be computed from the likelihood function p(xⱼ(t+T)|x₋ᵢ(t),θ) as

$$p ( {x}_{j} ( t + T ) \vert {x}_{- i} ( t ) , {θ}_{i} ) = {\sum }_{θ ∈ Θ}^{ } p ( θ \vert {x}_{- i} ( t ) , {θ}_{i} ) p ( {x}_{j} ( t + T ) \vert {x}_{- i} ( t ) , θ ) . \qquad ( 10 )$$

The term p(θ|x₋ᵢ(t),θᵢ) in Equation (35) expresses the joint probability of the types of each individual agent, that is, p(θ|x₋ᵢ(t),θᵢ)=p(θ₁, . . . , θ_{N}|x₋ᵢ(t),θᵢ). Two cases must be considered to compute the value of this probability. In the general case, the types of the agents are dependent on each other; in particular applications, the types of all agents may be independent, and therefore, the knowledge of an agent about one type does not affect his belief in the others.

Dependent Epistemic Types.

If the type of an agent depends on the types of other agents, the term p(θ|x₋ᵢ(t),θᵢ) can be computed in terms of conditional probabilities using the chain rule

$$\begin{matrix}p ( θ \vert {x}_{- i} ( t ) , {θ}_{i} ) = p ( {θ}_{1} , {θ}_{2} , … , {θ}_{N} \vert {x}_{- i} ( t ) , {θ}_{i} ) \\ = p ( {θ}_{1} \vert {x}_{- i} ( t ) , {θ}_{i} ) p ( {θ}_{2} \vert {x}_{- i} ( t ) , {θ}_{i} , {θ}_{1} ) … \times \\ p ( {θ}_{N} \vert {x}_{- i} ( t ) , {θ}_{i} , {θ}_{1} , … , {θ}_{N - 1} ) \\ = {\prod }_{j = 1}^{N} p ( {θ}_{j} \vert {x}_{- i} ( t ) , {θ}_{i} , {θ}_{1} , … , {θ}_{j - 1} )\end{matrix} \qquad ( 40 )$$

The products of Equation (40) can be separated in terms of the neighbors and non-neighbors of agent i as

$${\prod }_{j = 1}^{N} p ( {θ}_{j} \vert {x}_{- i} ( t ) , {θ}_{i} , {θ}_{1} , … , {θ}_{j - 1} ) = {\prod }_{j ∈ {N}_{i}}^{ } p ( {θ}_{j} \vert {x}_{- i} ( t ) , {θ}_{i} , {θ}_{1} , … , {θ}_{j - 1} ) \times {\prod }_{k ∉ {N}_{i}}^{ } p ( {θ}_{k} \vert {x}_{- i} ( t ) , {θ}_{i} , {θ}_{1} , … , {θ}_{k - 1} ) \qquad ( 11 )$$

Using expressions (37), (38), and (41), the Bayesian update of Equation (35) can be written as

$$p ( θ \vert {x}_{- i} ( t + T ) , {x}_{- i} ( t ) , {θ}_{i} ) = {\prod }_{j ∈ {N}_{i}}^{ } \frac{p ( {x}_{j} ( t + T ) \vert {x}_{- i} ( t ) , θ ) p ( {θ}_{j} \vert {x}_{- i} ( t ) , {θ}_{i} , {θ}_{1} , … , {θ}_{j - 1} )}{p ( {x}_{j} ( t + T ) \vert {x}_{- i} ( t ) , {θ}_{i} )} \times {\prod }_{k ∉ {N}_{i}}^{ } p ( {θ}_{k} \vert {x}_{- i} ( t ) , {θ}_{i} , {θ}_{1} , … , {θ}_{k - 1} ) \qquad ( 42 )$$

where the belief update with respect to the position of each neighbor is explicitly expressed, as desired.

Independent Epistemic Types.

In this case, agent i updates his beliefs about the other agents' types based only on his local information about the states of his neighbors. Thus, the expression

$$\begin{matrix}p ( θ \vert {x}_{- i} ( t ) , {θ}_{i} ) = p ( {θ}_{1} , {θ}_{2} , … , {θ}_{N} \vert {x}_{- i} ( t ) ) \\ = p ( {θ}_{1} \vert {x}_{- i} ( t ) ) p ( {θ}_{2} \vert {x}_{- i} ( t ) ) … p ( {θ}_{N} \vert {x}_{- i} ( t ) )\end{matrix} \qquad ( 43 )$$

is obtained.

Again, using expressions (37), (38), and (43), the belief update of agent i can be written as the product of the inference of each of his neighbors and his beliefs about his non-neighbors' types, as

$$p ( θ \vert {x}_{- i} ( t + T ) , {x}_{- i} ( t ) , {θ}_{i} ) = {\prod }_{j ∈ {N}_{i}}^{ } \frac{p ( {x}_{j} ( t + T ) \vert {x}_{- i} ( t ) , θ ) p ( {θ}_{j} \vert {x}_{- i} ( t ) )}{p ( {x}_{j} ( t + T ) \vert {x}_{- i} ( t ) , {θ}_{i} )} \times {\prod }_{k ∉ {N}_{i}}^{ } p ( {θ}_{k} \vert {x}_{- i} ( t ) ) . \qquad ( 12 )$$

As Equations (42) or (44) grow in number of factors, computing their value becomes computationally expensive. A usual solution to avoid this inconveniency is to calculate the log-probability to simplify the product of probabilities as the sum of their logarithms. This is expressed as

$$log p ( θ \vert {x}_{- i} ( t + T ) , {x}_{- i} ( t ) , {θ}_{i} ) = {\sum }_{j ∈ {N}_{i}}^{ } log \frac{p ( {x}_{j} ( t + T ) \vert {x}_{- i} ( t ) , θ ) p ( {θ}_{j} \vert {x}_{- i} ( t ) )}{p ( {x}_{j} ( t + T ) \vert {x}_{- i} ( t ) , {θ}_{i} )} + {\sum }_{k ∉ {N}_{i}}^{ } log p ( {θ}_{k} \vert {x}_{- i} ( t ) )$$

for the independent types case of Equation (44). A similar result can be obtained for the dependent types version of Equation (42).

Naïve Likelihood Approximation for Multiagent Systems in Graphs

A significant difficulty in computing the value of the Expression (44) is the limited knowledge of the agents due to the communication graph topology. It is of interest to design a method to estimate the likelihood Function (37) for agents that know only the state values of their neighbors and are unaware of the graph topology except for the links that allow them to observe such neighbors.

From Equation (37), agent i needs to compute the probabilities p(xⱼ(t+T)|x₋ᵢ(t),θ) for all his neighbors j. This can be done if agent i can predict the position xⱼ(t+T) for each possible combination of types θ and given the current states x₋ᵢ(t). However, i doesn't know if the value xⱼ(t+T) depends on the states of his neighbors x₋ᵢ(t) because the neighbors of agent j are unknown. The states of i's neighbors may or may not affect j's behavior.

Furthermore, the control policy of Equation (21) that agent j uses at time t depends not only on his type, but on his beliefs about the types of all other agents. The beliefs of agent j are also unknown to agent i. Due to these knowledge constraints, agent i must make assumptions about his neighbors to predict the state xⱼ(t+T) using only local information.

Let agent i make the naïve assumption that his other neighbors and himself are the neighbors of agent j. Thus, player i tries to predict the state of his neighbor j at time t+T for the case where i and j have the same state information available. Besides, agent i assumes that j is certain (i.e., assigns probability one) of the combination of types in question, θ.

Under these assumptions, agent i estimates the local synchronization error of agent j to be

$${\hat{δ}}_{j}^{i} = {\sum }_{k = 1}^{N} {a}_{ik} ( {x}_{j} - {x}_{k} ) + {g}_{i} ( {x}_{j} - {x}_{0} ) + ( {x}_{j} - {x}_{i} ) \qquad ( 13 )$$

which means that i expects the control policy of agent j with types θ to be

Eᵢ{uⱼ^{θ}}=−½(Rⱼⱼ^{θ})⁻¹B^{T}∇Vⱼ^{θ}(\hat{δ}ⱼⁱ) (14)
where the expected value operator is employed here in the sense that this is the value of uⱼ^{θ} that agent i expects given his limited knowledge. Considering a quadratic value function as in Equation (23), the expected policy of Equation (46) is written as

Eᵢ{uⱼ^{θ}}=−½(Rⱼⱼ^{θ})⁻¹B^{T}Pⱼ^{θ}\hat{δ}ⱼⁱ
with \hat{δ}ⱼⁱ defined in Equation (45).

Now, the probabilities p(xⱼ(t+T)|x₋ᵢ(t),θ) can be determined by defining a probability distribution for the state xⱼ(t+T). If a normal distribution is employed, then it is fully described by the mean μᵢⱼ^{θ} and the covariance Covᵢⱼ^{θ}, for neighbor j and types θ. In this case, the mean of the normal distribution function is the prediction of the state of agent j at time t+T, that is

μᵢⱼ^{θ}=\hat{x}ⱼ^{θ}(t+T) (15)
where \hat{x}ⱼ^{θ}(t+T) is the solution of the differential equation (1) for agent j at time t+T, with control policy of Equation (46), i.e.,

\hat{x}ⱼ^{θ}(t+T)=e^{A(t+T)}xⱼ(t)+∫ₜ^{t+T}e^{-A(τ-t-T)}BEᵢ{uⱼ^{θ}(τ)}dτ.
The covariance Covᵢⱼ^{θ} represents the lack of confidence of agent i about the previous naïve assumptions, and is selected according to the problem in hand.

Remark 9.

The intuition behind the naïve likelihood approximation for multiagent systems in graphs is inspired in the Naïve Bayes method for classification. However, the proposed assumptions made by the agents disclosed herein are different in nature and must not be confused.

Depending on the graph topology and the settings of the game, the proposed method for the likelihood calculation can differ considerably from reality. The effectiveness of the naïve likelihood approximation depends on the degree of accuracy of the assumptions made by the agents in a limited information environment. A measure of the uncertainty in the game is therefore useful in the analysis of the performance of the players.

In the following an uncertainty measure is introduced. In particular, the Bayesian game's index of uncertainty of agent i with respect to his neighbor j. For simplicity, assume that the graph weights are binary, i.e., aᵢⱼ=1 if agents i and j are neighbors, and aᵢⱼ=0 otherwise the general case when aᵢⱼ≥0 can be obtained with few modifications. The index of uncertainty is defined by comparing the center of gravity of the true neighbors of agent j, and the neighbors that agent i assumes for agent j.

Define the center of gravity of j's neighbors as

$${c}_{j} = \frac{{\sum }_{k = 1}^{N} {a}_{jk} {x}_{k}}{{\sum }_{k = 1}^{N} {a}_{jk}} . \qquad ( 16 )$$

When considering the virtual neighbors that agent i assigned to agent j, two mutually exclusive sets can be acknowledged: the assigned true neighbors, which are actually neighbors of j, and the assigned false neighbors, which are not neighbors of j. Let the center of gravity of the assigned true neighbors be

$${\hat{c}}_{ij}^{true} = \frac{{\sum }_{k = 1}^{N} {a}_{ik} {a}_{jk} {x}_{k} + {a}_{ji} {x}_{i}}{{\sum }_{k = 1}^{N} {a}_{ik} {a}_{jk} + {a}_{ji}} , j ∈ {N}_{i} \qquad ( 49 )$$

and the center of gravity of the assigned false neighbors is

$${\hat{c}}_{ij}^{false} = \frac{{\sum }_{k = 1}^{N} {a}_{ik} ( 1 - {a}_{jk} ) {x}_{k} + ( 1 - {a}_{ji} ) {x}_{i}}{{\sum }_{k = 1}^{N} {a}_{ik} ( 1 - {a}_{jk} ) + ( 1 - {a}_{ji} )} , j ∈ {N}_{i} \qquad ( 50 )$$

Finally, let θ* be the actual combination of types of the agents in the game, and pᵢ(θ*) the belief of agent j about θ*. The index of uncertainty is now defined as follows.

### Definition 4

Define the index of uncertainty of agent i about agent j as

$${υ}_{ij} = \frac{1}{2} \frac{‖ {c}_{j} - {\hat{c}}_{ij}^{true} + {\hat{c}}_{ij}^{false} ‖}{‖ {\hat{c}}_{ij}^{true} ‖} + \frac{1}{2} \frac{1 - {p}_{j} ( {θ}^{*} )}{{p}_{j} ( {θ}^{*} )} . \qquad ( 51 )$$

Thus, index νᵢⱼ measures how correct agent i was about the beliefs and the states of the neighbors of agent j. The following lemma shows that the index of uncertainty is a nonnegative scalar, with νᵢⱼ=0 if i is absolutely correct about j's neighbors and beliefs, and νᵢⱼ→∞ if the factors that influence j's behavior are completely unknown to i.

Lemma 2.

Let the index of uncertainty of agent i about his neighbor, agent j, in a Bayesian game be as in (51). Then, νᵢⱼ∈[0, ∞).

Proof.

Notice that cⱼ−ĉᵢⱼ^{true} is a pseudo-center of gravity of all agents that are neighbors of agent j but are not neighbors of i. Therefore, ∥cⱼ−ĉᵢⱼ^{true}+ĉᵢⱼ^{false}∥ is a measure of all the agents that agent i got wrong in his assumptions. If all of i's assignments are true, then ∥cⱼ−ĉᵢⱼ^{true}+ĉᵢⱼ^{false}∥=0. On the contrary, if all alleged neighbors of j were wrong, then ∥ĉᵢⱼ^{true}∥=0.

Similarly, it can be seen that the second term in Equation (51) is zero if pⱼ(θ*)=1, and it tends to infinity if pⱼ(θ*)=0.

Theorem 4 uses the index of uncertainty in Equation (51) to determine a sufficient condition for the beliefs of an agent to converge to the actual types of the game θ*. Lemma 3 is used in the proof of this theorem.

Lemma 3.

Let θ* be the actual combination of types in the game and consider the likelihood p(x₋ᵢ(t+T)|x₋ᵢ(t),θ) in (35). If the inequality

p(x₋ᵢ(t+T)|x₋ᵢ(t),θ*)>p(x₋ᵢ(t+T)|x₋ᵢ(t),θ′) (17)
holds for every combination of types θ′≠θ* at time instant t+T, then

p(θ*|x₋ᵢ(t+T),x₋ᵢ(t),θᵢ)>p(θ*|x₋ᵢ(t),δᵢ).

Proof.

Let Γᵢ(θ)=p(x₋ᵢ(t+T)|x₋ᵢ(t),θ) be the likelihood of agent i for types. Because Σ_{θ∈Θ}p(θ|x₋ᵢ(t),θᵢ)=1, we have

$$\begin{matrix}{Γ}_{i} ( {θ}^{*} ) = {Γ}_{i} ( {θ}^{*} ) {\sum }_{θ ∈ Θ}^{ } p ( θ \vert {x}_{- i} ( t ) , {θ}_{i} ) \\ = {Γ}_{i} ( {θ}^{*} ) p ( {θ}^{1} \vert {x}_{- i} ( t ) , {θ}_{i} ) + … + {Γ}_{i} ( {θ}^{*} ) p ( {θ}^{M} \vert {x}_{- i} ( t ) , {θ}_{i} ) > \\ {Γ}_{i} ( {θ}^{1} ) p ( {θ}^{1} \vert {x}_{- i} ( t ) , {θ}_{i} ) + … + {Γ}_{i} ( {θ}^{M} ) p ( {θ}^{M} \vert {x}_{- i} ( t ) , {θ}_{i} ) \\ = {\sum }_{θ ∈ Θ}^{ } {Γ}_{i} ( θ ) p ( θ \vert {x}_{- i} ( t ) , {θ}_{i} ) \\ = p ( {x}_{- i} ( t + T ) \vert {x}_{- i} ( t ) , {θ}_{i} )\end{matrix}$$

where inequality (52) was used in the third step, and the expression (39) was used in the last step. Now, from the Bayes rule (35) we can write

$$p ( {θ}^{*} \vert {x}_{- i} ( t + T ) , {x}_{- i} ( t ) , {θ}_{i} ) = \frac{{Γ}_{i} ( {θ}^{*} ) p ( {θ}^{*} \vert {x}_{- i} ( t ) , {θ}_{i} )}{p ( {x}_{- i} ( t + T ) \vert {x}_{- i} ( t ) , {θ}_{i} )} > p ( {θ}^{*} \vert {x}_{- i} ( t ) , {θ}_{i} )$$

which completes the proof.

Theorem 4.

Let the beliefs of the agents about the epistemic type θ be updated by means of the Bayesian rule of Equation (35), with the likelihood computed by means of a normal probability distribution with mean μᵢⱼ^{θ} as in Equation (47), and covariance Covᵢⱼ^{θ}. Then, the beliefs of agent i converge to the correct combination of types θ* if the index of uncertainty defined by Equation (51) is close to zero for all his neighbors j.

Proof.

Consider the case where νᵢⱼ=0; this occurs when the actual neighbors of agent j are precisely agent i and agent i's neighbors, and agent j assigns probability one to the combination of types θ*. This implies that the state value xⱼ(t+T) will be exactly the estimation \hat{x}ⱼ^{θ}(t+T) and the highest probability is obtained for the likelihood p(xⱼ(t+T)|x₋ᵢ(t),θ). By Lemma 3, the belief in type θ* is increased at every time step T, converging to 1.

If νᵢⱼ is an arbitrarily small positive number, then the center of gravity of the assigned neighbors is close to the center of gravity of the real neighbors of agent j. Furthermore, the beliefs of j in the combination of types θ* is close to 1. Now, the estimation of the state \hat{x}ⱼ^{θ′}(t+T) is arbitrarily close to the actual state xⱼ(t+T), making the likelihood p(xⱼ(t+T)|x₋ᵢ(t),θ*) larger than the likelihood of any other type θ. Again, the conditions of Lemma 3 hold and the belief in the type θ* converges to 1 at each iteration.

Remark 10.

A large value for the index of uncertainty expresses that an agent lacks enough information to understand the behavior of his neighbors. This implies that the beliefs of the agent cannot be corrected properly.

Remark 11.

The index of uncertainty is defined for analysis purposes and is unknown to the agents during the game. It allows a determination of whether the agents have enough information to find the actual combination of types of the game.

Non-Bayesian Belief Updates

The Bayesian belief update method presented in the previous section starts with the assumption that every agent knows his own type at the beginning of the game. In some applications, however, an agent can be uncertain about his type, or the concept of type can be ill-defined. In these cases, it is still possible to solve the Bayesian graphical game problem if more information is allowed to flow through the communication topology. In A. Jadbabaie, P. Molavi, A. Sandroni and A. Tahbaz-Salehi, “Non-Bayesian social learning,” Games and Economic Behavior, vol. 76, pp. 210-225, 2012, a non-Bayesian belief update algorithm is shown to efficiently converge to the type of the game θ. According to various embodiments, this method is used as an alternative to the proposed Bayesian update when every agent can communicate his beliefs about θ to his neighbors.

Let the belief update of player i to be computed as

$${p}_{i} ( θ \vert {x}_{- i} ( t + T ) , {x}_{- i} ( t ) ) = {b}_{ii} {p}_{i} ( θ \vert {x}_{- i} ( t ) ) \frac{{p}_{i} ( {x}_{- i} ( t + T ) \vert {x}_{- i} ( t ) , θ )}{{p}_{i} ( {x}_{- i} ( t + T ) \vert {x}_{- i} ( t ) )} + {\sum }_{j = 1}^{N} {a}_{ij} {p}_{j} ( θ ) \qquad ( 18 )$$

where pⱼ(θ) are the beliefs of agent j about θ, and the constant bᵢᵢ>0 is the weight that player i gives to his own beliefs relative to the graph weights aᵢⱼ assigned to his neighbors. Notice that it is required that Σⱼ₌₁^{N}aᵢⱼ+bᵢᵢ=1 for pᵢ(θ|x₋ᵢ(t+T),x₋ᵢ(t),θᵢ) to be a well-defined probability distribution.

Equation (53) expresses that the beliefs of agent i at time t+T is a linear combination of his own Bayesian belief update, and the beliefs of his neighbors at time t. This is regarded as a non-Bayesian belief update of the epistemic types.

Notice that Equation (53) does not consider the knowledge of θᵢ by agent i. The assumption that the agents can communicate their beliefs to their neighbors is meaningful when considering the case when the agents are uncertain about their own types; otherwise, they would be able to inform to their neighbors about their actual type through the communication topology.

Similar to Equation (42), the factors in the first term of Equation (53) can be decomposed in terms of the states and types of i neighbors as and non-neighbors, such that

$${p}_{i} ( θ \vert {x}_{- i} ( t + T ) , {x}_{- i} ( t ) ) = {b}_{ii} {\prod }_{j ∈ {N}_{i}}^{ } \frac{{p}_{i} ( {x}_{j} ( t + T ) \vert {x}_{- i} ( t ) , θ )}{{p}_{i} ( {x}_{j} ( t + T ) \vert {x}_{- i} ( t ) )} p ( {θ}_{j} \vert {x}_{- i} ( t ) , {θ}_{1} , … , {θ}_{j - 1} ) \times {\prod }_{k ∉ {N}_{i}}^{ } p ( {θ}_{k} \vert {x}_{- i} ( t ) , {θ}_{1} , … , {θ}_{k - 1} ) + {\sum }_{j = 1}^{N} {a}_{ij} {p}_{j} ( θ ) \qquad ( 19 )$$

where dependent epistemic types have been considered.

Simulation Results

In this section, two simulations are performed to show the behavior of the agents during a Bayesian graphical game using a Bayesian and a non-Bayesian belief updates. The solutions of the BHJI equations for Nash equilibrium are given.

Parameters for Simulation

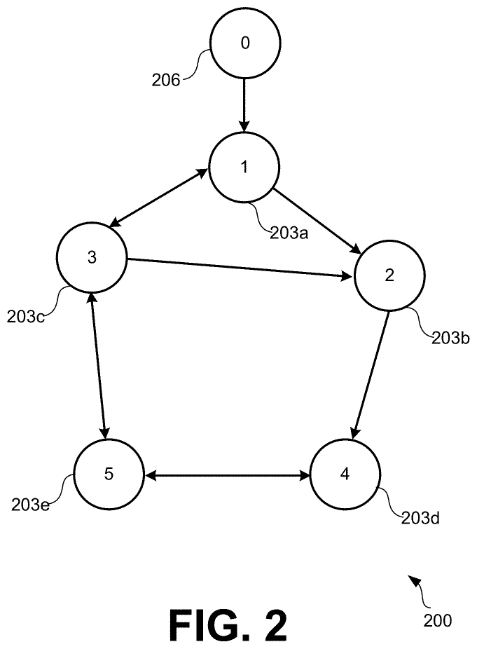

The agents try to achieve synchronization in this game. Consider a multi-agent system with five (5) agents 203 (e.g., 203a, 203b, 203c, 203d, 203e) and one (1) leader 206, connected in a directed graph 200 as shown in FIG. 2. All agents 203 are taken with single integrator dynamics, as

$${\dot{x}}_{i} = [ \begin{matrix}{\dot{x}}_{i , 1} \\ {\dot{x}}_{i , 2}\end{matrix} ] = [ \begin{matrix}{u}_{i , 1} \\ {u}_{i , 2}\end{matrix} ]$$

In this game, only agent 203a has two possible types, and all other agents 203 start with a prior knowledge of the probabilities of each type. Let agent 203a have type 1 40% of the cases, and type 2 60% of the cases.

The cost functions of the agents 203 are taken in the form of Equation (6), considering the same weighting matrices for all agents 203; that is, Qᵢⱼ^{θ}^{₁}=Qₖₗ^{θ}^{₁}, Rᵢⱼ^{θ}^{₁}=Rₖₗ^{θ}^{₁}, Qᵢⱼ^{θ}^{₂}=Qₖₗ^{θ}^{₂} and Rᵢⱼ^{θ}^{₂}=Rₖₗ^{θ}^{₂} for all i, j, k, l∈{1, 2, 3, 4, 5}. For type θ₁, the matrices are taken as

$${Q}_{ij}^{{θ}_{i}} = \frac{4}{10} [ \begin{matrix}I & - I \\ - I & 2 I\end{matrix} ] ,$$

Rᵢᵢ^{θ}^{₁}=10I and Rᵢⱼ^{θ}^{₁}=−20I for i≠j, where I is the identity matrix. The matrices of the cost functions for type θ₂ are taken as

$${Q}_{ij}^{{θ}_{2}} = [ \begin{matrix}16 I & - 16 I \\ - 16 I & 32 I\end{matrix} ] ,$$

Rᵢᵢ^{θ}^{₂}=I for all agents i, and Rᵢⱼ^{θ}^{₂}=−2I for i≠j.

To solve this game, a general formulation for the value functions of the game is considered, and then the control policies of the agents 203 are shown as optimal and distributed. Propose a value function with the form vᵢ^{θ}=Σⱼ₌₀^{N}aᵢⱼδ̅ᵢⱼ^{T}Pᵢ^{θ}δ̅ᵢⱼ, where aᵢ₀=gᵢ, δ̅ᵢ₀=[δᵢ^{T} 0^{T}]^{T} and δ̅ᵢⱼ=[δᵢ^{T} δⱼ^{T}]^{T} for j≠0, as solution for the cost function of Equations (5)- (6) for type θ. Notice that this value function is not necessarily distributed because it depends on the local information of the neighbors of agent i. This is proved below that, for type 1, matrix Pᵢ^{θ}^{ᵢ} has the form

$${P}_{i}^{{θ}_{1}} = [ \begin{matrix}I & 0 \\ 0 & 0\end{matrix} ] \qquad ( 20 )$$

and, for type 2,

$${P}_{i}^{{θ}_{2}} = [ \begin{matrix}2 I & 0 \\ 0 & 0\end{matrix} ] \qquad ( 21 )$$

for all agents, and hence distributed policies are obtained.

Express the expected Hamiltonian for agent i as

$${EH}_{i} = {\sum }_{θ = 1}^{2} {\sum }_{j = 0}^{N} p ( θ ) {a}_{ij} ( {\overline{δ}}_{ij}^{T} {Q}_{ij}^{θ} {\overline{δ}}_{ij} + {u}_{i}^{T} {R}_{ii}^{θ} {u}_{i} + {u}_{j}^{T} {R}_{ij}^{θ} {u}_{j} + 2 {\overline{δ}}_{ij}^{T} {P}_{i}^{θ} {{δ}^{\dot{\_}}}_{ij} )$$

where the derivative \overline{\dot{δ}}ᵢⱼ when j≠0 is given by

$$[ \begin{matrix}{\dot{δ}}_{i} \\ {\dot{δ}}_{j}\end{matrix} ] = [ \begin{matrix}A {δ}_{i} + ( {d}_{i} + {g}_{i} ) {Bu}_{i} - {\sum }_{k = 1}^{N} {a}_{ik} {Bu}_{k} \\ A {δ}_{j} + ( {d}_{j} + {g}_{j} ) {Bu}_{j} - {\sum }_{k = 1}^{N} {a}_{jk} {Bu}_{k}\end{matrix} ] .$$

From the expected Hamiltonian, the optimal control policies are obtained as

$${u}_{i}^{*} = - {( {\sum }_{θ = 1}^{2} p ( θ ) {R}_{ii}^{θ} )}^{- 1} {\sum }_{j = 0}^{N} \frac{{a}_{ij}}{{d}_{i} + {g}_{i}} [ \begin{matrix}( {d}_{i} + {g}_{i} ) {B}^{T} & - {a}_{ji} {B}^{T}\end{matrix} ] \times ( {\sum }_{θ = 1}^{2} p ( θ ) {P}_{i}^{θ} ) {\overline{δ}}_{ij} \qquad ( 22 )$$

which are not necessarily distributed. Using the policies uᵢ* for all agents, the BHJI equations that must be solved by matrices Pᵢ^{θ} are

$${\sum }_{θ = 1}^{2} {\sum }_{j = 1}^{N} p ( θ ) {a}_{ij} ( {\overline{δ}}_{ij}^{T} {Q}_{ij}^{θ} {\overline{δ}}_{ij} + {u}_{i}^{* T} {R}_{ii}^{θ} {u}_{i}^{*} + {u}_{j}^{* T} {R}_{ij}^{θ} {u}_{j}^{*} + 2 {\overline{δ}}_{ij}^{T} {P}_{i}^{θ} {{δ}^{\dot{\_}}}_{ij}^{*} ) = 0. \qquad ( 23 )$$

To show that (57) with Pᵢ^{θ} as in (58) is the optimal policy for agent i, express the expected cost of agent i as

$${EJ}_{i} = {\int }_{0}^{∞} {\sum }_{θ ∈ Θ} {\sum }_{j = 1}^{N} p ( θ ) {a}_{ij} ( {\overline{δ}}_{ij}^{T} {Q}_{ij}^{θ} {\overline{δ}}_{ij } + {u}_{i}^{T} {R}_{ii}^{θ} {u}_{i} + {u}_{j}^{T} {R}_{ij}^{θ} {u}_{j} ) dt + {\sum }_{θ ∈ Θ} p ( θ ) {\int }_{0}^{∞} {\dot{V}}_{i}^{θ} dt + {\sum }_{θ ∈ Θ} p ( θ ) {V}_{i}^{θ} ( δ ( 0 ) ) .$$

Similarly as in Lemma 1, it is easy to show that

$${EJ}_{i} = {\int }_{0}^{∞} {\sum }_{θ ∈ Θ} {\sum }_{j = 1}^{N} p ( θ ) {a}_{ij} ( {\overline{δ}}_{ij}^{T} {Q}_{ij}^{θ} {\overline{δ}}_{ij} + {u}_{i}^{* T} {R}_{ii}^{θ} {u}_{i}^{*} + {u}_{j}^{T} {R}_{ij}^{θ} {u}_{j} ) dt + {\sum }_{θ ∈ Θ} p ( θ ) {\int }_{0}^{∞} {\dot{V}}_{i}^{θ} dt + {\sum }_{θ ∈ Θ} p ( θ ) {\int }_{0}^{∞} {( {u}_{i} - {u}_{i}^{*} )}^{T} {R}_{ii} ( {u}_{i} - {u}_{i}^{*} ) dt + {\sum }_{θ ∈ Θ} p ( θ ) {V}_{i}^{θ} ( δ ( 0 ) )$$

for all uᵢ and u₋ᵢ. As Equation (58) holds, if all neighbors of agent i use their best strategies u₋ᵢ*, then

$${EJ}_{i} = {\sum }_{θ ∈ Θ} p ( θ ) [ {\int }_{0}^{∞} {( {u}_{i} - {u}_{i}^{*} )}^{T} {R}_{ii} ( {u}_{i} - {u}_{i}^{*} ) dt + {V}_{i}^{θ} ( δ ( 0 ) ) ]$$

and uᵢ* in Equation (57) is indeed the optimal strategy of agent i.

To show that Matrices (55) and (56) solve Equations (58) for all agents 203, substitute the matrices in the value functions Vᵢ^{θ} and the policies uᵢ* of the agents 203. Thus, for type θ₁, we can write Vᵢ^{θ}^{₁}=(dᵢ+gᵢ)δᵢ^{T}δᵢ; for type θ₂, Vᵢ^{θ}^{₂}=2(dᵢ+gᵢ)δᵢ^{T}δᵢ; and the optimal control policies are given by

$${u}_{i}^{*} = - ( {d}_{i} + {g}_{i} ) {( {\sum }_{θ = 1}^{2} p ( θ ) {R}_{ii}^{θ} )}^{- 1} {B}^{T} ( p ( {θ}_{1} ) I + 2 p ( {θ}_{2} ) I ) {δ}_{i} .$$

Notice that Matrices (55) and (56) make uᵢ* distributed. Using the Expressions (54) and (55) and the cost functions of the game, we obtain the following result for type θ₁

$$= {\sum }_{j = 0}^{N} {a}_{ij} ( \frac{4}{10} {\overline{δ}}_{ij}^{T} [ \begin{matrix}I & - I \\ - I & 2 I\end{matrix} ] {\overline{δ}}_{ij} + 10 {u}_{i}^{T} {u}_{i} - 20 {u}_{j}^{T} {u}_{j} ) + 2 {\sum }_{j = 0}^{N} {a}_{ij} ( {\overline{δ}}_{ij}^{T} [ \begin{matrix}I & 0 \\ 0 & 0\end{matrix} ] ( 2 {u}_{i} - {\sum }_{j = 1}^{N} {a}_{ij} {u}_{j} ) ) = {\sum }_{j = 0}^{N} {a}_{ij} ( \frac{4}{10} {δ}_{i}^{T} {δ}_{i} - \frac{8}{10} {δ}_{i}^{T} {δ}_{j} + \frac{8}{10} {δ}_{j}^{T} {δ}_{j} + 10 {u}_{i}^{T} {u}_{i} - 20 {u}_{j}^{T} {u}_{j} ) + 2 {\sum }_{j = 0}^{N} {a}_{ij} ( {δ}_{i}^{T} ( ( 2 {u}_{i} - {\sum }_{j = 1}^{N} {a}_{ij} {u}_{j} ) )$$

Substituting uᵢ* and uⱼ* provides

$${\sum }_{j = 0}^{N} {a}_{ij} ( \frac{4}{10} {δ}_{i}^{T} {δ}_{i} - \frac{8}{10} {δ}_{i}^{T} {δ}_{j} + \frac{8}{10} {δ}_{j}^{T} {δ}_{j} + \frac{4}{10} {δ}_{i}^{T} {δ}_{i} - \frac{8}{10} {δ}_{j}^{T} {δ}_{j} ) - {\sum }_{j = 0}^{N} {a}_{ij} ( \frac{8}{10} {δ}_{i}^{T} {δ}_{i} + \frac{4}{10} {\sum }_{j = 1}^{N} {a}_{ij} {δ}_{i}^{T} {δ}_{j} ) = {\sum }_{j = 0}^{N} {a}_{ij} ( \frac{4}{10} {δ}_{i}^{T} {δ}_{i} - \frac{8}{10} {δ}_{i}^{T} {δ}_{j} + \frac{8}{10} {δ}_{i}^{T} {δ}_{j} + \frac{4}{10} {δ}_{i}^{T} {δ}_{i} - \frac{8}{10} {δ}_{j}^{T} {δ}_{j} - \frac{8}{10} {δ}_{i}^{T} {δ}_{i} + \frac{8}{10} {\sum }_{j = 1}^{N} {a}_{ij} {δ}_{i}^{T} {δ}_{j} ) = 0$$

Similarly, for type θ₂ the following

$${\sum }_{j = 0}^{N} {a}_{ij} ( {\overline{δ}}_{ij}^{T} {Q}_{ij}^{{θ}_{2}} {\overline{δ}}_{ij} + {u}_{i}^{T} {R}_{ii}^{{θ}_{2}} {u}_{i} + {u}_{j}^{T} {R}_{ij}^{{θ}_{2}} {u}_{j} ) + ∇ {V}_{i}^{θ T} ( A {δ}_{i} + ( {d}_{i} + {g}_{i} ) {Bu}_{i} - {\sum }_{j = 1}^{N} {a}_{ij} {Bu}_{j} ) = {\sum }_{j = 0}^{N} {a}_{ij} ( {\overline{δ}}_{ij}^{T} [ \begin{matrix}16 I & - 16 I \\ - 16 I & 32 I\end{matrix} ] {\overline{δ}}_{ij} + {u}_{i}^{T} {u}_{i} - 2 {u}_{j}^{T} {u}_{j} ) + 2 {\sum }_{j = 0}^{N} {a}_{ij} ( {\overline{δ}}_{ij}^{T} [ \begin{matrix}2 I & 0 \\ 0 & 0\end{matrix} ] ( 2 {u}_{i} - {\sum }_{j = 1}^{N} {a}_{ij} {u}_{j} ) ) = {\sum }_{j = 0}^{N} {a}_{ij} ( 16 {δ}_{i}^{T} {δ}_{i} - 32 {δ}_{i}^{T} {δ}_{j} + 32 {δ}_{j}^{T} {δ}_{j} + {u}_{i}^{T} {u}_{i} - 2 {u}_{j}^{T} {u}_{j} ) + 4 {\sum }_{j = 0}^{N} {a}_{ij} ( {δ}_{i}^{T} ( ( 2 {u}_{i} - {\sum }_{j = 1}^{N} {a}_{ij} {u}_{j} ) ) = {\sum }_{j = 0}^{N} {a}_{ij} ( 16 {δ}_{i}^{T} {δ}_{i} - 32 {δ}_{i}^{T} {δ}_{j} + 32 {δ}_{j}^{T} {δ}_{j} + 16 {δ}_{i}^{T} {δ}_{i} - 32 {δ}_{j}^{T} {δ}_{j} ) - {\sum }_{j = 0}^{N} {a}_{ij} ( 32 {δ}_{i}^{T} {δ}_{i} + 16 {\sum }_{j = 1}^{N} {a}_{ij} {δ}_{i}^{T} {δ}_{j} ) = {\sum }_{j = 0}^{N} {a}_{ij} ( 16 {δ}_{i}^{T} {δ}_{i} - 32 {δ}_{i}^{T} {δ}_{j} + 32 {δ}_{j}^{T} {δ}_{j} + 16 {δ}_{i}^{T} {δ}_{i} - 32 {δ}_{j}^{T} {δ}_{j} - 32 {δ}_{i}^{T} {δ}_{i} + 32 {\sum }_{j = 1}^{N} {a}_{ij} {δ}_{i}^{T} {δ}_{j} ) = 0$$

Finally, the BHJI equations for all agents, i=1, . . . , 5, can be written as

$$p ( {θ}_{1} ) ( {\sum }_{j = 0}^{N} {a}_{ij} ( {\overline{δ}}_{ij}^{T} {Q}_{ij}^{{θ}_{1}} {\overline{δ}}_{ij} + {u}_{i}^{T} {R}_{ii}^{{θ}_{1}} + {u}_{j}^{T} {R}_{ij}^{{θ}_{1}} {u}_{j} ) + ∇ {V}_{i}^{{θ}_{1} T} ( A {δ}_{i} + ( {d}_{i} + {g}_{i} ) {Bu}_{i} - {\sum }_{j = 1}^{N} {a}_{ij} {Bu}_{j} ) ] + p ( {θ}_{2} ) [ {\sum }_{j = 0}^{N} {a}_{ij} ( {\overline{δ}}_{ij}^{T} {Q}_{ij}^{{θ}_{2}} {\overline{δ}}_{ij} + {u}_{i}^{T} {R}_{ii}^{{θ}_{2}} {u}_{i} + {u}_{j}^{T} {R}_{ij}^{{θ}_{2 }} {u}_{j} ) + ∇ {V}_{i}^{{θ}_{2} T} ( A {δ}_{i} + ( {d}_{i} + {g}_{i} ) {Bu}_{i} - {\sum }_{j = 1}^{N} {a}_{ij} {Bu}_{j} ) ] = 0$$

Therefore, matrices Pᵢ^{θ}^{₁} and Pᵢ^{θ}^{₂} are the solutions of the game. As the control policies obtained from these matrices are distributed, this numerical example has shown a system for which Assumption 1 holds.

### Bayesian Belief Update

With the exception of agent 203a, all players update their beliefs about the type θ every 0.1 seconds, using a Bayesian belief update of Equation (44) with naïve likelihood approximation. During this simulation, agent 203a is in type 1.

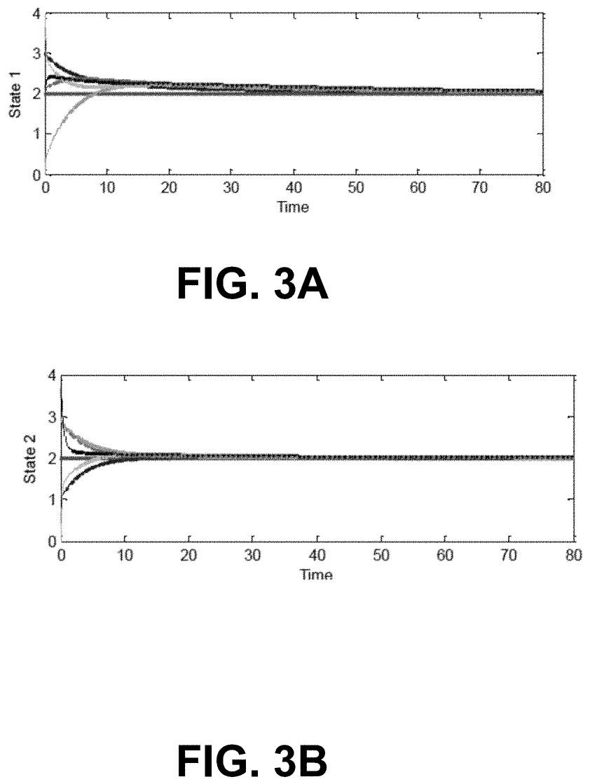

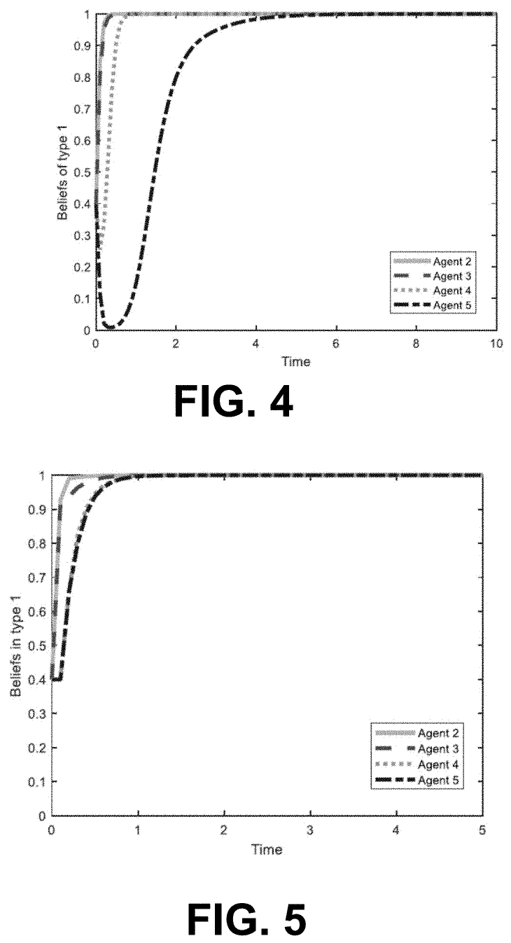

The state dynamics of the agents 203a are shown in FIGS. 3A and 3B, where FIG. 3A illustrates the trajectories of the five agents 203 in a first state and FIG. 3B illustrates a graphical representation of the trajectories of the five agents 203 in a second state. In FIG. 4, the evolution of the beliefs of every agent 203 is displayed. Note that all beliefs approach probability one for type θ₁, and all agents end up playing the same game.

Non-Bayesian Belief Update

The simulation is now repeated using Equation (54) for the non-Bayesian belief update. Agent 1 (e.g., agent 203a) is again in type 1, and agents 2 to 5 (e.g., agents 203b-203e) share their individual beliefs about θ₁ with their neighbors according to the communication graph topology.

FIG. 5 illustrates a graphical representation of the beliefs of agents 2-5 (e.g., agents 203b-203e). In particular, FIG. 5 illustrates shows the convergence of the beliefs in type 1 of the four agents 203. Convergence is considerably faster in this case, due to the additional information the agents 203 possess when they communicate their beliefs with each other.

### CONCLUSION

Multiagent systems analysis was performed for dynamical agents 203 engaged on interactions with uncertain objectives. The tight relationship between the beliefs of an agent 203 and his distributed best response control policy is revealed for the first time. The Bayes-Nash equilibrium were proved for the best response control policy to achieve under general conditions. The proposed naïve likelihood approximation is a useful method to deal with the limited knowledge of the agents about the graph topology, provided that its restrictive assumptions do not excessively differ from the actual game environment.

Simulations with two different belief update algorithms show the applicability of the proposed methods. The Bayesian belief update has the advantage of not requiring an additional communication scheme, achieving convergence of the beliefs using solely measurements of the states of their neighbors. The non-Bayesian updates take advantage of a supplementary information to achieve a faster and more robust convergence of the beliefs to the true type of the game.

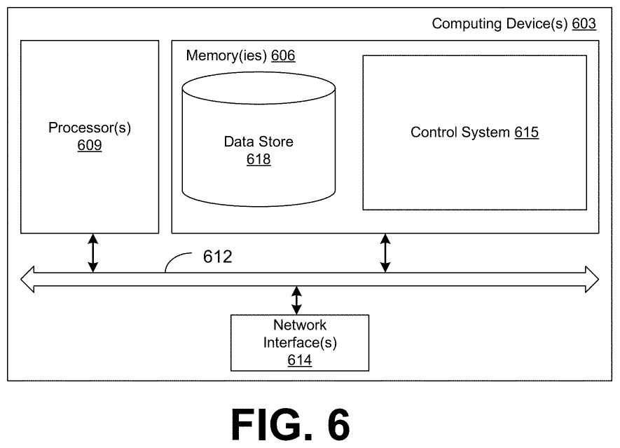

FIG. 6 shows a schematic block diagram of a computing device 603 of an agent 203. Each computing device 603 includes at least one processor circuit, for example, having a processor 609 and a memory 606, both of which are coupled to a local interface 612. To this end, each computing device 603 may comprise, for example, at least one server computer or like device, which can be utilized in a cloud based environment. The local interface 612 may comprise, for example, a data bus with an accompanying address/control bus or other bus structure as can be appreciated.

In some embodiments, the computing device 603 can include one or more network interfaces 614. The network interface 614 may comprise, for example, a wireless transmitter, a wireless transceiver, and/or a wireless receiver. The network interface 614 can communicate to a remote computing device or other components of the disclosed system using a Bluetooth, WiFi, or other appropriate wireless protocol. As one skilled in the art can appreciate, other wireless protocols may be used in the various embodiments of the present disclosure.

Stored in the memory 606 are both data and several components that are executable by the processor 609. In particular, stored in the memory 606 and executable by the processor 609 can be a control system 615, and potentially other applications. In this respect, the term “executable” means a program file that is in a form that can ultimately be run by the processor 609. Also stored in the memory 606 may be a data store 618 and other data. In addition, an operating system may be stored in the memory 606 and executable by the processor 609. It is understood that there may be other applications that are stored in the memory 606 and are executable by the processor 609 as can be appreciated.

Examples of executable programs may be, for example, a compiled program that can be translated into machine code in a format that can be loaded into a random access portion of the memory 606 and run by the processor 609, source code that may be expressed in proper format such as object code that is capable of being loaded into a random access portion of the memory 606 and executed by the processor 609, or source code that may be interpreted by another executable program to generate instructions in a random access portion of the memory 606 to be executed by the processor 609, etc. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

The memory 606 is defined herein as including both volatile and nonvolatile memory and data storage components. Volatile components are those that do not retain data values upon loss of power. Nonvolatile components are those that retain data upon a loss of power. Thus, the memory 606 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 609 may represent multiple processors 609 and/or multiple processor cores, and the memory 606 may represent multiple memories 606 that operate in parallel processing circuits, respectively. In such a case, the local interface 612 may be an appropriate network that facilitates communication between any two of the multiple processors 609, between any processor 609 and any of the memories 606, or between any two of the memories 606, etc. The local interface 612 may comprise additional systems designed to coordinate this communication, including, for example, performing load balancing. The processor 609 may be of electrical or of some other available construction.

Although the control system 615, and other various applications described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein, including the control system 615, that comprises software or code can be embodied in any non-transitory computer-readable medium for use by or in connection with an instruction execution system such as, for example, a processor 609 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the control system 615, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 603, or in multiple computing devices in the same computing environment. To this end, each computing device 603 may comprise, for example, at least one server computer or like device, which can be utilized in a cloud based environment.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A control system, comprising:
a first computing device; and
at least one application executable in the first computing device, wherein, when executed, the at least one application causes the first computing device to at least:
establish a first control policy associated with the first computing device based at least in part on an incomplete knowledge of an environment and a plurality of goals;
collect state information from a neighboring second computing device;
update a belief in an intention of the neighboring second computing device based at least in part on the state information; and
modify the first control policy based at least in part on the updated belief.

2. The control system of claim 1, wherein the first computing device is in data communication with a plurality of second computing devices included in the environment, the neighboring second computing device being one of the plurality of second computing devices, and individual second computing devices implementing respective second control policies based at least in part on a respective second plurality of goals.

3. The control system of claim 2, wherein each computing device of the first computing device and the plurality of second computing devices comprise a first type of knowledge and a second type of knowledge, the first type of knowledge comprising a common prior knowledge that is the same for each computing device, the second type of knowledge defining a respective agent type based at least in part on personal information and a respective list of goals, and the second type of knowledge being unique for individual computing devices.

4. The control system of claim 1, wherein the belief is updated without knowledge of the intention of the neighboring second computing device.

5. The control system of claim 1, wherein the first control policy is based at least in part on a combination of Hamilton-Jacobi-Isaacs equations with a Bayesian algorithm.

6. The control system of claim 1, wherein the control system is a continuous-time dynamic system.

7. The control system of claim 1, wherein the environment includes a plurality of autonomous vehicles, and the first computing device being configured to control a first autonomous vehicle of the plurality of autonomous vehicles.

8. A method for controlling a first agent participating in a Bayesian game with a plurality of second agents in an environment, comprising:
establishing, via an agent computing device, a control policy for actions by the first agent in the environment based at least in part on a plurality of goals;
obtaining, via the agent computing device, state information from at least one neighboring agent computing device included in the environment;
updating, via the agent computing device, a belief in one or more intentions of the at least one neighboring agent computing device based at least in part on the state information; and
modifying, via the agent computing device, the control policy based at least in part on the updated belief.

9. The method of claim 8, wherein the belief is updated based on a non-Bayesian belief algorithm.

10. The method of claim 8, further comprising identifying, via the agent computing device, a plurality of neighboring agent computing devices, the agent computing device in data communication with the plurality of neighboring agent computing devices;

11. The method of claim 8, wherein the one or more intentions of the at least one neighboring agent computing device are unknown to the agent computing device.

12. The method of claim 8, wherein the control policy is based at least in part on a combination of Hamilton-Jacobi-Isaacs equations with a Bayesian algorithm

13. The method of claim 8, wherein each agent in the environment comprises a first type of knowledge and a second type of knowledge, the first type of knowledge comprising a common prior knowledge that is the same for each agent, the second type of knowledge defining a respective agent type based at least in part on personal information and a list of goals, and the second type of knowledge being unique for individual agents.

14. The method of claim 8, wherein the agents comprise a plurality of autonomous vehicles.

15. A non-transitory computer readable medium for dynamically adjusting a control policy, the non-transitory computer readable medium comprising machine-readable instructions that, when executed by a processor of a first agent device, cause the first agent device to at least:
establish a first control policy based at least in part on an incomplete knowledge of an environment and a plurality of goals;
collect state information from a neighboring second agent device;
update a belief in an intention of the neighboring second agent device based at least in part on the state information; and
modify the first control policy based at least in part on the updated belief.

16. The non-transitory computer readable medium of claim 15, wherein the first agent is in data communication with a plurality of second agent devices included in the environment, the neighboring second agent device being one of the plurality of second agent devices, and individual second agents implementing respective second control policies based at least in part on a respective second plurality of goals.

17. The non-transitory computer readable medium of claim 16, wherein each agent device comprises a first type of knowledge and a second type of knowledge, the first type of knowledge comprising a common prior knowledge that is the same for each agent device, the second type of knowledge defining a respective agent type based at least in part on personal information and a respective list of goals, and the second type of knowledge being unique for individual agent devices.

18. The non-transitory computer readable medium of claim 15, wherein the belief is updated without knowledge of the intention of the neighboring second agent device.

19. The non-transitory computer readable medium of claim 15, wherein the first control policy is based at least in part on a combination of Hamilton-Jacobi-Isaacs equations with a Bayesian algorithm.

20. The non-transitory computer readable medium of claim 15, wherein the first agent device implements a continuous-time dynamic system.
